(19) United States
(12) Patent Application Publication
(10) Pub. No.: US 2026/0125624 A1
(43) Pub. Date: May 7, 2026

(54) MODIFIED DISTILLER'S GRAINS, PREPARATION METHOD THEREOF, AND USE THEREOF

(71) Applicant: Moutai Institute, Renhuai (CN)

(72) Inventors: Chen Yu, Zibo (CN); Yaxi Liu, Shanghai (CN); Juan Li, Guiyang (CN); Haiyan Zhang, Panzhou (CN); Zhangming Chen, Zunyi (CN); Zunyi Yuan, Zunyi (CN); Zhihao Chen, Zhumadian (CN); Yi Gao, Shijiazhuang (CN)

(21) Appl. No.: 19/348,844

(22) Filed: Oct. 3, 2025

(30) Foreign Application Priority Data
Nov. 6, 2024 (CN) 2024115745839

(51) Int. Cl. C12C 1/02; C12C 1/067

(52) U.S. Cl. CPC C12C 1/02; C12C 1/067

(57) ABSTRACT

A modified distiller's, a preparation method thereof, and a use thereof are provided, which relate to the field of composite material preparation. Coupling agents with different reactive groups and hyperbranched resins with different terminal reactive groups are used, and through synergistic effect of the coupling agent and the hyperbranched resin, the surface of distiller's grains powder is regulated. This approach solves problems of poor interfacial compatibility between the distiller's grains powder and the biodegradable resin, as well as agglomeration of the distiller's grains powder due to strong hydrogen bonding. As a result, the compatibility and interfacial bonding strength between the distiller's grains powder and the biodegradable resin are enhanced, leading to the production of a high-performance fully biodegradable green composite material.

### CROSS-REFERENCE TO RELATED APPLICATION

This application claims priority to Chinese Patent Application No. 202411574583.9, filed on Nov. 6, 2024, which is herein incorporated by reference in its entirety.

### TECHNICAL FIELD

The disclosure relates to the field of composite material preparation, and more particularly to a modified distiller's grains, a preparation method thereof, and a use thereof.

### BACKGROUND

Green composite materials are a category of composite materials that use renewable biomass resources as raw materials, and at least one of constituent materials is derived from natural resources and is capable of complete biodegradation. In recent years, with the increasing scarcity of petrochemical polymer materials and their composite resources and the growing environmental protection requirements, the demand for green and environmentally friendly materials has been growing. Biodegradable composite materials prepared with natural biomass fillers, as a type of green and environmentally friendly material, attract widespread market attention. Over the past few years, researchers have successfully prepared green composite materials by using a variety of the biomass fillers, such as rice husk powder, bamboo powder, cellulose, lignin, etc. Owing to their abundant availability and natural biodegradability, the biomass fillers have become one of the most popular types of fillers.

Distiller's grains are solid waste products obtained from a brewing process after cereals such as wheat and sorghum have been steamed, fermented, and distilled to extract alcoholic beverages. They are generated in substantial quantities. The distiller's grains exhibit high moisture content, significant acidity, and are prone to spoilage and decomposition. Inappropriate handling may lead to severe ecological and environmental pollution. Therefore, it is necessary to implement treatment processes aimed at reduction, detoxification, and resource recovery of the distiller's grains.

Studies have shown that the distiller's grains contain abundant hemicellulose and lignin, which can be used as biomass fillers to further reduce the cost of the composite materials and have received sustained attention in recent years. In addition to cellulose and lignin, the distiller's grains also contain a wealth of nutrients and various active functional components, including alcohols, acids, aldehydes, esters, proteins, amino acids, bioactive peptides, functional oligosaccharides, antioxidant phenols, and flavonoids, which have high utilization value and great development potential and are an important resource. Promoting the resource utilization of the distiller's grains to turn waste into treasure and achieve green circular development, and conducting research on the high-value utilization of the distiller's grains is urgent.

### SUMMARY

To solve the above problems, an embodiment the disclosure provides a preparation method of a modified distiller's grains, including the following steps:
(1) crushing distiller's grains, followed by drying, grinding, and sieving to obtain distiller's grains powder;
(2) adding a coupling agent to the distiller's grains powder, followed by heating and stirring to obtain coupling agent-treated distiller's grains; and
(3) adding a hyperbranched resin to the coupling agent-treated distiller's grains, followed by heating, stirring for 5 minutes (min) to 45 min, and cooling to room temperature to obtain the modified distiller's grains.

In an embodiment, a drying temperature of the drying in the step (1) is 80° C. to 120° C., and a particle size of the distiller's grains powder is 100 mesh to 2,000 mesh.

In an embodiment, the coupling agent in the step (2) is at least one selected from the group consisting of a silane coupling agent, an aluminum stearate coupling agent, and a titanate coupling agent, and a weight ratio of the distiller's grains powder to the coupling agent is (10:1) to (300:1).

Furthermore, in an embodiment, the silane coupling agent is at least one selected from the group consisting of γ-glycidoxypropyltrimethoxysilane and γ-aminopropyltriethoxysilane; and the titanate coupling agent is isopropyl tri(dioctylpyrophosphate) titanate.

In an embodiment, the hyperbranched resin in the step (3) is at least one selected from the group consisting of amino-terminated hyperbranched polyester, carboxyl-terminated hyperbranched polyester, hydroxyl-terminated hyperbranched polyester, hyperbranched epoxy resin, hydroxyl-terminated hyperbranched polyamide, and amino-terminated hyperbranched polyamide, and a weight ratio of the distiller's grains powder to the hyperbranched resin is (5:1) to (300:1).

Another embodiment of the disclosure provides a distiller's grains-based fully biodegradable green composite material. In terms of weight percent (wt %), a composition of the distiller's grain-based fully biodegradable green composite material includes: 5 wt % to 95 wt % of biodegradable polyester, 0.1 wt % to 15 wt % of chain extender, 1 wt % to 75 wt % of the modified distiller's grains, 0.1 wt % to 5 wt % of anti-hydrolysis agent, 0.1 wt % to 5 wt % of thermal stabilizer, and 0.1 wt % to 7.5 wt % of lubricant, and the modified distiller's grains is prepared by the preparation method described above.

In an embodiment, the biodegradable polyester is at least one selected from the group consisting of poly(butylene adipate-co-terephthalate) (PBAT), polylactic acid (PLA), poly(butylene succinate) (PBS), poly(butylene succinate-co-butylene adipate) (PBSA), poly(propylene carbonate) (PPC), poly(glycolic acid) (PGA), poly(ε-caprolactone) (PCL), poly(hydroxyalkanoate) (PHA), poly(hydroxybutyrate) (PHB), poly(hydroxyvalerate) (PHV), and poly(hydroxybutyrate-co-hidroxyvalerate) (PHBV); the chain extender is at least one selected from the group consisting of an epoxy compound chain extender and a styrene-methyl acrylate copolymer chain extender; the anti-hydrolysis agent is at least one selected from the group consisting of a carbodiimide compound, an isocyanate compound, a bisoxazoline compound, and an epoxy compound; the thermal stabilizer is at least one selected from the group consisting of an aromatic amine compound, a hindered phenol compound, a phosphite compound, and a thioester compound; and the lubricant is at least one selected from the group consisting of a long-chain carboxylic acid, an amide wax, a carboxylic acid ester, a carboxylic acid salt, and an organosilicon resin.

Still another embodiment of the disclosure provides a preparation method of the distiller's grains-based fully biodegradable green composite material describe above, including:
mixing the biodegradable polyester, the chain extender, the anti-hydrolysis agent, thermal stabilizer, and the lubricant to obtain a biodegradable polyester mixture; and
mixing the biodegradable polyester mixture with the modified distiller's grains, followed by drying thoroughly to obtain the distiller's grains-based fully biodegradable green composite material.

Even still another embodiment of the disclosure provides a use of the distiller's grains-based fully biodegradable green composite material described above as a material for blow molding, injection molding, cast film extrusion, rotational molding, three-dimensional (3D) printing, extrusion, coating, spinning, thermoforming, and compression molding.

The disclosure may achieve the following beneficial effects.

(1) The disclosure provides a large-scale and high-value utilization of the distiller's grains, a by-product of a brewing process. The disclosure employs the coupling agents with different reactive groups to chemically react with reactive groups present in the distiller's grains, the hyperbranched resins, and the biodegradable resins. The hyperbranched resins with different terminal reactive groups are selectively chosen to match different types of the coupling agents. Through the synergistic effect of the coupling agents and the hyperbranched resins, the surface of the distiller's grains powder is modified and controllably treated. This approach solves problems of poor interfacial compatibility between the distiller's grains powder and the biodegradable resins, as well as the agglomeration of distiller's grains powder particles caused by strong intermolecular hydrogen bonding, which leads to inferior performance. Consequently, the disclosure enhances the compatibility and interfacial bonding strength between the distiller's grains and the biodegradable resin, resulting in a high-performance biodegradable green composite material.

(2) The composite material provided by the disclosure simultaneously increases the filler loading of the distiller's grains powder while meeting product standards and performance requirements. This expands the application fields of the distiller's grains-based biodegradable green composite material, thereby accelerating the consumption of the distiller's grains, preventing resource waste and severe environmental pollution. It delivers certain economic benefits while also generating social and ecological benefits.

(3) Matrix resins used in the disclosure are all fully biodegradable resins. The distiller's grains is also used as a green biobased filler and added into the biodegradable resin. The resulting composite material can be completely biodegraded within a certain environment and time frame. This truly achieves the reduction, harmlessness, and resource utilization of the distiller's grains.

(4) The processing technology for the distiller's grains powder and the preparation technology for the green fully biodegradable composite material in the disclosure are convenient and feasible, with high production efficiency and economic benefits, and have great prospects for industrial application.

### DETAILED DESCRIPTION OF EMBODIMENTS

Various exemplary embodiments of the disclosure are described in detail below. Unless otherwise specified, methods used in the embodiments are conventional methods, and reagents used are either commercially available conventional reagents or reagents prepared by using conventional methods. This detailed description should not be construed as a limitation of the disclosure, but rather as a more detailed description of certain aspects, features, and implementation schemes of the disclosure.

It should be understood that terms used in the disclosure are merely for a purpose of describing specific embodiments and are not intended to limit the disclosure. Furthermore, with regard to numerical ranges disclosed in the disclosure, it should be understood that every intermediate value between upper and lower limits of the range is also specifically disclosed. Every intermediate value within any stated value or any stated range, and every smaller range between any other stated values or intermediate value within the stated range, is also encompassed within the scope of the disclosure. The upper and lower limits of these smaller ranges can be included or excluded independently from the range.

Unless otherwise specified, all technical and scientific terms used in this text have same meanings as generally understood by those skilled in the art to which the disclosure pertains. Although specific methods and materials are described, any similar or equivalent methods and materials may also be used in the practice or testing of the disclosure. All references mentioned in the specification are incorporated by reference to disclose and describe the methods and/or materials related to cited references. In the event of any conflict with any incorporated reference, the content of the specification shall prevail.

Without departing from the scope or spirit of the disclosure, various modifications and variations may be made to the specific embodiments described in the specification, which would be apparent to those skilled in the art. Other embodiments obtained from the specification of disclosure are obvious to those skilled in the art. The specification and the embodiments of the disclosure are only exemplary.

Terms such as “includes”, “consist of”, “have” and “contain” used in this text are all open-ended terms, meaning they include but are not limited to.

Unless otherwise specified, all raw materials used in the embodiments are commercially available products.

PBAT resin, TH801T, is purchased from Xinjiang Blue Ridge Tunhe Science and Technology Co., Ltd.

PLA resin, Luminy® LX175, is purchased from TotalEnergies Corbion.

PPC resin, T4, is purchased from Jiangsu Zhongke Jinlong Chemical Co., Ltd.

PBS resin, FZ71PM, is purchased from PTT MCC Biochem Company Limited.

PBSA resin, FD92PB, is purchased from PTT MCC Biochem Company Limited.

PHBV resin, Y1000, is purchased from Ningbo Tian'an Biomaterial Co., Ltd.

PGA resin, RESOMER® G 205 S, is purchased from Evonik.

PCL resin, Esun 1000C, is purchased from Shenzhen Guanghua Weiye Co., Ltd.

Coupling agents γ-aminopropyltriethoxysilane (also referred to as KH-550), γ-glycidoxypropyltrimethoxysilane (also referred to as KH-560), and isopropyltri(dioctylpyrophosphato)titanate (also referred to as NDZ-201) are all purchased from Nanjing Shuguang Chemical Group Co., Ltd.

### Embodiment 1

Preparation of modified distiller's grains: (1) Distiller's grains from Chinese liquor are crushed, thoroughly washed in water, filtered to remove water, and then dried in a drying oven at 100° C. to remove moisture to obtain dried distiller's grains. The dried distiller's grains are then ground in a mill and sieved to a particle size of 1,250 mesh to obtain distiller's grains powder. The distiller's grains powder is added to a high-speed mixer, a rotational speed of the high-speed mixer is set to 1,000 radians per minute (rad/min), and a temperature of the high-speed mixer is raised to 100° C. Under high-speed stirring, coupling agent KH560 is gradually added to the high-speed mixer containing the distiller's grains powder while stirring, in a weight ratio of the distiller's grains powder (wt %) to the coupling agent (wt %) of 50:1. After the addition is completed, a material temperature is controlled at 100° C. with stirring for 30 min to obtain KH560-treated distiller's grains powder. (2) Subsequently, carboxyl-terminated hyperbranched polyester Hyper C304 is added to the high-speed mixer containing the KH560-treated distiller's grains powder prepared above to obtain a mixture in a weight ratio of the distiller's grains powder (wt %) to the hyperbranched resin (wt %) of 50:1. The rotational speed of the high-speed mixer is set to 1,000 rad/min, and the material temperature is controlled at 100° C. with stirring for 30 min. After completion, heating is stopped, and the mixture is cooled to room temperature with stirring at a low speed of 100 revolutions per minute (rpm) to obtain jointly modified distiller's grains treated with KH560 and Hyper C304 (i.e., modified distiller's grains 1 #), which is set aside for later use.

Preparation of distiller's grains-based fully biodegradable green composite material: (1) Biodegradable polyesters PBAT and PLA are placed in drying apparatuses separately for thorough drying. After drying, PBAT (53.9 wt %) and PLA (23.1 wt %), along with chain extender Joncryl® ADR 4468 (commonly known as epoxy-functionalized acrylic copolymer and purchased from Badische Anilin-und-Soda-Fabrik (BASF) Corporation) (0.8 wt %), anti-hydrolysis agent polycarbodiimide (1.6 wt %), thermal stabilizer 1010 (commonly known as pentaerythritol tetrakis(3-(3,5-di-tert-butyl-4-hydroxyphenyl) propionate) and purchased from BASF Corporation) (0.2 wt %), thermal stabilizer 168 (commonly known as tris(2,4-di-tert-butylphenyl) phosphite and purchased from BASF Corporation) (0.2 wt %), and lubricant erucamide (0.2 wt %) are weighed according to the aforementioned weight percentages and added to a high-speed mixer. A temperature of the high-speed mixer is set to room temperature, a rotational speed of the high-speed mixer is set to 1,000 rad/min, and a mixing time of the high-speed mixer is set to 10 min, thereby obtaining mixture 1 #. (2) The aforementioned mixture 1 #and the modified distiller's grains 1 #are placed into hoppers of separate automatic loss-in-weight feeders. Feeding parameters of the separate automatic loss-in-weight feeders are set according to a weight ratio of the mixture 1 #(wt %) to the modified distiller's grains 1 #(wt %) of 80:20. Then a mixture composed of the mixture 1 #and the modified distiller's grains 1 #is extruded through a twin-screw extruder, followed by stranding, cooling, and pelletizing to obtain pellets. The resulting pellets are thoroughly dried to obtain distiller's grains-based fully biodegradable green composite material 1 #. During this processing, a temperature of the twin-screw extruder is set to 180° C., and a rotation speed of main engine of the twin-screw extruder is set to 300 rpm.

### Embodiment 2

### Preparation of Modified Distiller's Grains: As Described in the Embodiment 1.

Preparation of distiller's grains-based fully biodegradable green composite material: (1) Biodegradable polyesters PBAT and PLA are placed in drying apparatuses separately for thorough drying. After drying, PBAT (47.04 wt %) and PLA (20.16 wt %), along with chain extender Joncryl® ADR 4468 (0.7 wt %), anti-hydrolysis agent polycarbodiimide (1.4 wt %), thermal stabilizer 1010 (0.2 wt %) and thermal stabilizer 168 (0.2 wt %), and lubricant erucamide (0.3 wt %) are weighed according to the aforementioned weight percentages and added to a high-speed mixer. A temperature of the high-speed mixer is set to room temperature, a rotational speed of the high-speed mixer is set to 1,000 rad/min, and a mixing time of the high-speed mixer is set to 10 min, thereby obtaining mixture 2 #. (2) The aforementioned mixture 2 #and the modified distiller's grains 1 #are separately placed into hoppers of different automatic loss-in-weight feeders. Feeding parameters of the automatic loss-in-weight feeders are set according to a weight ratio of the mixture 2 #(wt %) to the modified distiller's grains 1 #(wt %) of 70:30. Then a mixture composed of the mixture 2 #and the modified distiller's grains 1 #is extruded through a twin-screw extruder, followed by stranding, cooling, and pelletizing to obtain pellets. The resulting pellets are thoroughly dried to obtain distiller's grains-based fully biodegradable green composite material 2 #. During this processing, a temperature of the twin-screw extruder is set to 180° C., and a rotation speed of main engine of the twin-screw extruder is set to 300 rpm.

### Embodiment 3

### Preparation of Modified Distiller's Grains: As Described in the Embodiment 1.

Preparation of distiller's grains-based fully biodegradable green composite material: (1) Biodegradable polyesters PBAT and PLA are placed in drying apparatuses separately for thorough drying. After drying, PBAT (40.18 wt %) and PLA (17.22 wt %), along with chain extender Joncryl® ADR 4468 (0.6 wt %), anti-hydrolysis agent polycarbodiimide (1.2 wt %), thermal stabilizer 1010 (0.2 wt %) and thermal stabilizer 168 (0.2 wt %), and lubricant erucamide (0.4 wt %) are weighed according to the aforementioned weight percentages and added to a high-speed mixer. A temperature of the high-speed mixer is set to room temperature, a rotational speed of the high-speed mixer is set to 1,000 rad/min, and a mixing time of the high-speed mixer is set to 10 min, thereby obtaining mixture 3 #. (2) The aforementioned mixture 3 #and the modified distiller's grains 1 #are each placed into hoppers of separate automatic loss-in-weight feeders. Feeding parameters of the separate automatic loss-in-weight feeders are set according to a weight ratio of the mixture 3 #(wt %) to the modified distiller's grains 1 #(wt %) of 60:40. Then a mixture composed of the mixture 3 #and the modified distiller's grains 1 #is extruded through a twin-screw extruder, followed by stranding, cooling, and pelletizing to obtain pellets. The resulting pellets are thoroughly dried to obtain distiller's grains-based fully biodegradable green composite material 3 #. During this processing, a temperature of the twin-screw extruder is set to 180° C., and a rotation speed of main engine of the twin-screw extruder is set to 300 rpm.

### Embodiment 4

### Preparation of Modified Distiller's Grains: As Described in the Embodiment 1.

Preparation of distiller's grains-based fully biodegradable green composite material: (1) Biodegradable polyesters PBAT and PLA are placed in drying apparatuses separately for thorough drying. After drying, PBAT (33.32 wt %) and PLA (14.28 wt %), along with chain extender Joncryl® ADR 4468 (0.5 wt %), anti-hydrolysis agent polycarbodiimide (1.0 wt %), thermal stabilizer 1010 (0.2 wt %) and thermal stabilizer 168 (0.2 wt %), and lubricant erucamide (0.5 wt %) are weighed according to the aforementioned weight percentages and added to a high-speed mixer. A temperature of the high-speed mixer is set to room temperature, a rotational speed of the high-speed mixer is set to 1,000 rad/min, and a mixing time of the high-speed mixer is set to 10 min, thereby obtaining mixture 4 #. (2) The aforementioned mixture 4 #and the modified distiller's grains 1 #are each placed into hoppers of separate automatic loss-in-weight feeders. Feeding parameters of the separate automatic loss-in-weight feeders are set according to a weight ratio of the mixture 4 #(wt %) to the modified distiller's grains 1 #(wt %) of 50:50. Then a mixture composed of the mixture 4 #and the modified distiller's grains 1 #is extruded through a twin-screw extruder, followed by stranding, cooling, and pelletizing to obtain pellets. The resulting pellets are thoroughly dried to obtain distiller's grains-based fully biodegradable green composite material 4 #. During this processing, a temperature of the twin-screw extruder is set to 180° C., and a rotation speed of main engine of the twin-screw extruder is set to 300 rpm.

### Embodiment 5

Preparation of modified distiller's grains: (1) Distiller's grains are treated with a coupling agent as described in the embodiment 1 to obtain KH560-treated distiller's grains powder. (2) Subsequently, carboxyl-terminated hyperbranched polyester Hyper C181 is added to the high-speed mixer containing the KH560-treated distiller's grains powder prepared above to obtain a mixture in a weight ratio of the distiller's grains powder (wt %) to the hyperbranched resin (wt %) of 50:1. The rotational speed of the high-speed mixer is set to 1,000 rad/min, and the material temperature is controlled at 100° C. with stirring for 30 min. After completion, heating is stopped, and the mixture is cooled to room temperature with stirring at a low speed of 100 rpm to obtain jointly modified distiller's grains treated with KH560 and Hyper C181 (i.e., modified distiller's grains 2 #), which is set aside for later use.

Preparation of distiller's grains-based fully biodegradable green composite material: The mixture 2 #and the modified distiller's grains 2 #are placed into hoppers of different automatic loss-in-weight feeders separately. Feeding parameters of the automatic loss-in-weight feeders are set according to a weight ratio of the mixture 2 #(wt %) to the modified distiller's grains 2 #(wt %) of 70:30. Then a mixture composed of the mixture 2 #and the modified distiller's grains 2 #is extruded through a twin-screw extruder, followed by stranding, cooling, and pelletizing to obtain pellets. The resulting pellets are thoroughly dried to obtain distiller's grains-based fully biodegradable green composite material 5 #. During this processing, a temperature of the twin-screw extruder is set to 180° C., and a rotation speed of main engine of the twin-screw extruder is set to 300 rpm.

### Embodiment 6

Preparation of modified distiller's grains: (1) Distiller's grains from Chinese liquor are crushed, thoroughly washed in water, filtered to remove water, and then dried in a drying oven at 100° C. to remove moisture to obtain dried distiller's grains. The dried distiller's grains are then ground in a mill and sieved to a particle size of 1,250 mesh to obtain distiller's grains powder. The distiller's grains powder is added to a high-speed mixer, a rotational speed of the high-speed mixer is set to 1,000 rad/min, and a temperature of the high-speed mixer is raised to 100° C. Under high-speed stirring, coupling agent KH550 is gradually added to the high-speed mixer containing the distiller's grains powder while stirring, in a weight ratio of the distiller's grains powder (wt %) to the coupling agent (wt %) of 50:1. After the addition is completed, a material temperature is controlled at 100° C. with stirring for 30 min to obtain KH550-treated distiller's grains powder. (2) Subsequently, hyperbranched epoxy resin Hyper E102 is added to the high-speed mixer containing the KH550-treated distiller's grains powder prepared above to obtain a mixture in a weight ratio of the distiller's grains powder (wt %) to the hyperbranched resin (wt %) of 50:1. The rotational speed of the high-speed mixer is set to 1,000 rad/min, and the material temperature is controlled at 100° C. with stirring for 30 min. After completion, heating is stopped, and the mixture is cooled to room temperature with stirring at a low speed of 100 rpm to obtain jointly modified distiller's grains treated with KH550 and Hyper E102 (i.e., modified distiller's grains 3 #), which is set aside for later use.

Preparation of distiller's grains-based fully biodegradable green composite material: The mixture 2 #and the modified distiller's grains 3 #are placed into hoppers of different automatic loss-in-weight feeders separately. Feeding parameters of the automatic loss-in-weight feeders are set according to a weight ratio of the mixture 2 #(wt %) to the modified distiller's grains 3 #(wt %) of 70:30. Then a mixture composed of the mixture 2 #and the modified distiller's grains 3 #is extruded through a twin-screw extruder, followed by stranding, cooling, and pelletizing to obtain pellets. The resulting pellets are thoroughly dried to obtain distiller's grains-based fully biodegradable green composite material 6 #. During this processing, a temperature of the twin-screw extruder is set to 180° C., and a rotation speed of main engine of the twin-screw extruder is set to 300 rpm.

### Embodiment 7

Preparation of modified distiller's grains: (1) Distiller's grains from Chinese liquor are crushed, thoroughly washed in water, filtered to remove water, and then dried in a drying oven at 100° C. to remove moisture to obtain dried distiller's grains. The dried distiller's grains are then ground in a mill and sieved to a particle size of 1,250 mesh to obtain distiller's grains powder. The distiller's grains powder is added to a high-speed mixer, a rotational speed of the high-speed mixer is set to 1,000 rad/min, and a temperature is raised to 100° C. Under high-speed stirring, coupling agent NDZ-201 is gradually added to the high-speed mixer containing the distiller's grains powder while stirring, in a weight ratio of the distiller's grains powder (wt %) to the coupling agent (wt %) of 50:1. After the addition is completed, a material temperature is controlled at 100° C. with stirring for 30 min to obtain NDZ-201-treated distiller's grains powder. (2) Subsequently, carboxyl-terminated hyperbranched polyester Hyper C304 is added to the high-speed mixer containing the NDZ-201-treated distiller's grains powder prepared above to obtain a mixture in a weight ratio of the distiller's grains powder (wt %) to the hyperbranched resin (wt %) of 50:1. The rotational speed of the high-speed mixer is set to 1,000 rad/min, and the material temperature is controlled at 100° C. with stirring for 30 min. After completion, heating is stopped, and the mixture is cooled to room temperature with stirring at a low speed of 100 rpm to obtain jointly modified distiller's grains treated with NDZ-201 and Hyper C304 (i.e., modified distiller's grains 4 #), which is set aside for later use.

Preparation of distiller's grains-based fully biodegradable green composite material: The mixture 2 #and the modified distiller's grains 4 #are placed into hoppers of different automatic loss-in-weight feeders. Feeding parameters of the different automatic loss-in-weight feeders are set according to a weight ratio of the mixture 2 #(wt %) to the modified distiller's grains 4 #(wt %) of 70:30. Then a mixture composed of the mixture 2 #and the modified distiller's grains 4 #is extruded through a twin-screw extruder, followed by stranding, cooling, and pelletizing to obtain pellets. The resulting pellets are thoroughly dried to obtain distiller's grains-based fully biodegradable green composite material 7 #. During this processing, a temperature of the twin-screw extruder is set to 180° C., and a rotation speed of main engine of the twin-screw extruder is set to 300 rpm.

### Embodiment 8

Preparation of modified distiller's grains: (1) Distiller's grains are treated with a coupling agent as described in the embodiment 7 to obtain NDZ-201-treated distiller's grains powder. (2) Subsequently, carboxyl-terminated hyperbranched polyester Hyper C181 is added to the high-speed mixer containing the NDZ-201-treated distiller's grains powder prepared above to obtain a mixture in a weight ratio of the distiller's grains powder (wt %) to the hyperbranched resin (wt %) of 50:1. The rotational speed of the high-speed mixer is set to 1,000 rad/min, and the material temperature is controlled at 100° C. with stirring for 30 min. After completion, heating is stopped, and the mixture is cooled to room temperature with stirring at a low speed of 100 rpm to obtain jointly modified distiller's grains treated with NDZ-201 and Hyper C181 (i.e., modified distiller's grains 5 #), which is set aside for later use.

Preparation of distiller's grains-based fully biodegradable green composite material: The mixture 2 #and the modified distiller's grains 5 #are placed into hoppers of different automatic loss-in-weight feeders. Feeding parameters of the different automatic loss-in-weight feeders are set according to a weight ratio of the mixture 2 #(wt %) to the modified distiller's grains 5 #(wt %) of 70:30. Then a mixture composed of the mixture 2 #and the modified distiller's grains 5 #is extruded through a twin-screw extruder, followed by stranding, cooling, and pelletizing to obtain pellets. The resulting pellets are thoroughly dried to obtain distiller's grains-based fully biodegradable green composite material 8 #. During this processing, a temperature of the twin-screw extruder is set to 180° C., and a rotation speed of main engine of the twin-screw extruder is set to 300 rpm.

### Embodiment 9

Preparation of modified distiller's grains: (1) Distiller's grains are treated with a coupling agent as described in the embodiment 6 to obtain KH550-treated distiller's grains powder. (2) Subsequently, carboxyl-terminated hyperbranched polyester Hyper C304 is added to the high-speed mixer containing the KH550-treated distiller's grains powder prepared above to obtain a mixture in a weight ratio of the distiller's grains powder (wt %) to the hyperbranched resin (wt %) of 50:1. The rotational speed of the high-speed mixer is set to 1,000 rad/min, and the material temperature is controlled at 100° C. with stirring for 30 min. After completion, heating is stopped, and the mixture is cooled to room temperature with stirring at a low speed of 100 rpm to obtain jointly modified distiller's grains treated with KH550 and Hyper C304 (i.e., modified distiller's grains 6 #), which is set aside for later use.

Preparation of distiller's grains-based fully biodegradable green composite material: The mixture 2 #and the modified distiller's grains 6 #are placed into hoppers of different automatic loss-in-weight feeders. Feeding parameters of the different automatic loss-in-weight feeders are set according to a weight ratio of the mixture 2 #(wt %) to the modified distiller's grains 6 #(wt %) of 70:30. Then a mixture composed of the mixture 2 #and the modified distiller's grains 6 #is extruded through a twin-screw extruder, followed by stranding, cooling, and pelletizing to obtain pellets. The resulting pellets are thoroughly dried to obtain distiller's grains-based fully biodegradable green composite material 9 #. During this processing, a temperature of the twin-screw extruder is set to 180° C., and a rotation speed of main engine of the twin-screw extruder is set to 300 rpm.

### Embodiment 10

Preparation of modified distiller's grains: (1) Distiller's grains are treated with a coupling agent as described in the embodiment 6 to obtain KH550-treated distiller's grains powder. (2) Subsequently, carboxyl-terminated hyperbranched polyester Hyper C181 is added to the high-speed mixer containing the KH550-treated distiller's grains powder prepared above to obtain a mixture in a weight ratio of the distiller's grains powder (wt %) to the hyperbranched resin (wt %) of 50:1. The rotational speed of the high-speed mixer is set to 1,000 rad/min, and the material temperature is controlled at 100° C. with stirring for 30 min. After completion, heating is stopped, and the mixture is cooled to room temperature with stirring at a low speed of 100 rpm to obtain jointly modified distiller's grains treated with KH550 and Hyper C181 (i.e., modified distiller's grains 7 #), which is set aside for later use.

Preparation of distiller's grains-based fully biodegradable green composite material: The mixture 2 #and the modified distiller's grains 7 #are placed into hoppers of separate automatic loss-in-weight feeders. Feeding parameters of the separate automatic loss-in-weight feeders are set according to a weight ratio of the mixture 2 #(wt %) to the modified distiller's grains 7 #(wt %) of 70:30. Then a mixture composed of the mixture 2 #and the modified distiller's grains 7 #is extruded through a twin-screw extruder, followed by stranding, cooling, and pelletizing to obtain pellets. The resulting pellets are thoroughly dried to obtain distiller's grains-based fully biodegradable green composite material 10 #. During this processing, a temperature of the twin-screw extruder is set to 180° C., and a rotation speed of main engine of the twin-screw extruder is set to 300 rpm.

### Embodiment 11

Preparation of modified distiller's grains: (1) Distiller's grains are treated with a coupling agent as described in the embodiment 1 to obtain KH560-treated distiller's grains powder. (2) Subsequently, amino-terminated hyperbranched polyester Amine Functional Boltorn™ H40 is added to the high-speed mixer containing the KH560-treated distiller's grains powder prepared above to obtain a mixture in a weight ratio of the distiller's grains powder (wt %) to the hyperbranched resin (wt %) of 50:1. The rotational speed of the high-speed mixer is set to 1,000 rad/min, and the material temperature is controlled at 100° C. with stirring for 30 min. After completion, heating is stopped, and the mixture is cooled to room temperature with stirring at a low speed of 100 rpm to obtain jointly modified distiller's grains treated with KH560 and Amine Functional Boltorn™ H40 (i.e., modified distiller's grains 8 #), which is set aside for later use.

Preparation of distiller's grains-based fully biodegradable green composite material: The mixture 2 #and the modified distiller's grains 8 #are placed into hoppers of separate automatic loss-in-weight feeders. Feeding parameters of the different automatic loss-in-weight feeders are set according to a weight ratio of the mixture 2 #(wt %) to the modified distiller's grains 8 #(wt %) of 70:30. Then a mixture composed of the mixture 2 #and the modified distiller's grains 8 #is extruded through a twin-screw extruder, followed by stranding, cooling, and pelletizing to obtain pellets. The resulting pellets are thoroughly dried to obtain distiller's grains-based fully biodegradable green composite material 11 #. During this processing, a temperature of the twin-screw extruder is set to 180° C., and a rotation speed of main engine of the twin-screw extruder is set to 300 rpm.

### Embodiment 12

Preparation of modified distiller's grains: (1) Distiller's grains are treated with a coupling agent as described in the embodiment 1 to obtain KH560-treated distiller's grains powder. (2) Subsequently, hydroxyl-terminated hyperbranched polyester Boltorn™ Regular H40 is added to the high-speed mixer containing the KH560-treated distiller's grains powder prepared above to obtain a mixture in a weight ratio of the distiller's grains powder (wt %) to the hyperbranched resin (wt %) of 50:1. The rotational speed of the high-speed mixer is set to 1,000 rad/min, and the material temperature is controlled at 100° C. with stirring for 30 min. After completion, heating is stopped, and the mixture is cooled to room temperature with stirring at a low speed of 100 rpm to obtain jointly modified distiller's grains treated with KH560 and Boltorn™ Regular H40 (i.e., modified distiller's grains 9 #), which is set aside for later use.

Preparation of distiller's grains-based fully biodegradable green composite material: The mixture 2 #and the modified distiller's grains 9 #are placed into hoppers of different automatic loss-in-weight feeders. Feeding parameters of the different automatic loss-in-weight feeders are set according to a weight ratio of the mixture 2 #(wt %) to the modified distiller's grains 9 #(wt %) of 70:30. Then a mixture composed of the mixture 2 #and the modified distiller's grains 9 #is extruded through a twin-screw extruder, followed by stranding, cooling, and pelletizing to obtain pellets. The resulting pellets are thoroughly dried to obtain distiller's grains-based fully biodegradable green composite material 12 #. During this processing, a temperature of the twin-screw extruder is set to 180° C., and a rotation speed of main engine of the twin-screw extruder is set to 300 rpm.

### Embodiment 13

Preparation of modified distiller's grains: (1) Distiller's grains from Chinese liquor are crushed, thoroughly washed in water, filtered to remove water, and then dried in a drying oven at 80° C. to remove moisture to obtain dried distiller's grains. The dried distiller's grains are then ground in a mill and sieved to a particle size of 100 mesh to obtain distiller's grains powder. The distiller's grains powder is added to a high-speed mixer, a rotational speed of the high-speed mixer is set to 2,000 rad/min, and a temperature is raised to 90° C. Under high-speed stirring, coupling agent KH560 is gradually added to the high-speed mixer containing the distiller's grains powder while stirring, in a weight ratio of the distiller's grains powder (wt %) to the coupling agent (wt %) of 100:1. After the addition is completed, a material temperature is controlled at 90° C. with stirring for 5 min to obtain KH560-treated distiller's grains powder. (2) Subsequently, hydroxyl-terminated hyperbranched polyester Hyper H304 is added to the high-speed mixer containing the KH560-treated distiller's grains powder prepared above to obtain a mixture in a weight ratio of the distiller's grains powder (wt %) to the hyperbranched resin (wt %) of 25:1. The rotational speed of the high-speed mixer is set to 100 rad/min, and the material temperature is controlled at 90° C. with stirring for 45 min. After completion, heating is stopped, and the mixture is cooled to room temperature with stirring at a low speed of 100 rpm to obtain jointly modified distiller's grains treated with KH560 and Hyper H304 (i.e., modified distiller's grains 10 #), which is set aside for later use.

Preparation of distiller's grains-based fully biodegradable green composite material: The mixture 2 #and the modified distiller's grains 10 #are placed into hoppers of separate automatic loss-in-weight feeders. Feeding parameters of the separate automatic loss-in-weight feeders are set according to a weight ratio of the mixture 2 #(wt %) to the modified distiller's grains 10 #(wt %) of 70:30. Then a mixture composed of the mixture 2 #and the modified distiller's grains 10 #is extruded through a twin-screw extruder, followed by stranding, cooling, and pelletizing to obtain pellets. The resulting pellets are thoroughly dried to obtain distiller's grains-based fully biodegradable green composite material 13 #. During this processing, a temperature of the twin-screw extruder is set to 180° C., and a rotation speed of main engine of the twin-screw extruder is set to 300 rpm.

### Embodiment 14

Preparation of modified distiller's grains: (1) Distiller's grains from Chinese liquor are crushed, thoroughly washed in water, filtered to remove water, and then dried in a drying oven at 120° C. to remove moisture to obtain dried distiller's grains. The dried distiller's grains are then ground in a mill and sieved to a particle size of 2,000 mesh to obtain distiller's grains powder. The distiller's grains powder is added to a high-speed mixer, a rotational speed of the high-speed mixer is set to 100 rad/min, and a temperature is raised to 110° C. Under high-speed stirring, coupling agent NDZ-201 is gradually added to the high-speed mixer containing the distiller's grains powder while stirring, in a weight ratio of the distiller's grains powder (wt %) to the coupling agent (wt %) of 25:1. After the addition is completed, a material temperature is controlled at 110° C. with stirring for 45 min to obtain NDZ-201-treated distiller's grains powder. (2) Subsequently, hyperbranched epoxy resin Hyper E102 is added to the high-speed mixer containing the KH560-treated distiller's grains powder prepared above to obtain a mixture in a weight ratio of the distiller's grains powder (wt %) to the hyperbranched resin (wt %) of 100:1. The rotational speed of the high-speed mixer is set to 2,000 rad/min, and the material temperature of the high-speed mixer is controlled at 110° C. with stirring for 5 min. After completion, heating is stopped, and the mixture is cooled to room temperature with stirring at a low speed of 100 rpm to obtain jointly modified distiller's grains treated with NDZ-201 and Hyper E102 (i.e., modified distiller's grains 11 #), which is set aside for later use.

Preparation of distiller's grains-based fully biodegradable green composite material: The mixture 2 #and the modified distiller's grains 11 #are placed into hoppers of different automatic loss-in-weight feeders. Feeding parameters of the different automatic loss-in-weight feeders are set according to a weight ratio of the mixture 2 #(wt %) to the modified distiller's grains 11 #(wt %) of 70:30. Then a mixture composed of the mixture 2 #and the modified distiller's grains 11 #is extruded through a twin-screw extruder, followed by stranding, cooling, and pelletizing to obtain pellets. The resulting pellets are thoroughly dried to obtain distiller's grains-based fully biodegradable green composite material 14 #. During this processing, a temperature of the twin-screw extruder is set to 180° C., and a rotation speed of main engine of the twin-screw extruder is set to 300 rpm.

### Embodiment 15

Preparation of modified distiller's grains: the only difference from the embodiment 1 in this embodiment is that the distiller's grains used here are beer distiller's grains, and all other products and processes are the same as the embodiment 1, resulting in modified distiller's grains 12 #.

Preparation of distiller's grains-based fully biodegradable green composite material: The mixture 2 #and the modified distiller's grains 12 #are placed into hoppers of different automatic loss-in-weight feeders separately. Feeding parameters of the separate automatic loss-in-weight feeders are set according to a weight ratio of the mixture 2 #(wt %) to the modified distiller's grains 12 #(wt %) of 70:30. Then a mixture composed of the mixture 2 #and the modified distiller's grains 12 #is extruded through a twin-screw extruder, followed by stranding, cooling, and pelletizing to obtain pellets. The resulting pellets are thoroughly dried to obtain distiller's grains-based fully biodegradable green composite material 15 #. During this processing, a temperature of the twin-screw extruder is set to 180° C., and a rotation speed of main engine of the twin-screw extruder is set to 300 rpm.

### Embodiment 16

Preparation of modified distiller's grains: the only difference from the embodiment 1 in this embodiment is that the distiller's grains used here are yellow rice wine (huangjiu) distiller's grains, and all other products and processes are the same as the embodiment 1, resulting in modified distiller's grains 13 #.

Preparation of distiller's grains-based fully biodegradable green composite material: The mixture 2 #and the modified distiller's grains 13 #are placed into hoppers of different automatic loss-in-weight feeders separately. Feeding parameters of the different automatic loss-in-weight feeders are set according to a weight ratio of the mixture 2 #(wt %) to the modified distiller's grains 13 #(wt %) of 70:30. Then a mixture composed of the mixture 2 #and the modified distiller's grains 13 #is extruded through a twin-screw extruder, followed by stranding, cooling, and pelletizing to obtain pellets. The resulting pellets are thoroughly dried to obtain distiller's grains-based fully biodegradable green composite material 16 #. During this processing, a temperature of the twin-screw extruder is set to 180° C., and a rotation speed of main engine of the twin-screw extruder is set to 300 rpm.

### Embodiment 17

### Preparation of Modified Distiller's Grains: As Described in the Embodiment 1, Modified Distiller's Grains 1 #is Obtained and Set Aside for Later Use.

Preparation of distiller's grains-based fully biodegradable green composite material: (1) Biodegradable polyester PPC is placed in a drying apparatus for thorough drying. After drying, PPC (67.6 wt %), chain extender epoxy-functionalized styrene-acrylate copolymer Relysorb® 4468 (purchased from Relyon New Materials Co., Ltd.) (0.7 wt %), anti-hydrolysis agent monomeric carbodiimide (1.0 wt %), thermal stabilizer 1076 (commonly known as octadecyl 3-(3,5-di-tert-butyl-4-hydroxyphenyl) propionate and purchased from BASF Corporation) (0.2 wt %), thermal stabilizer 168 (0.2 wt %), and lubricant palmitic acid (0.3 wt %) are weighed according to the aforementioned weight percentages and added to a high-speed mixer. A temperature of the high-speed mixer is set to room temperature, a rotational speed of the high-speed mixer is set to 1,000 rad/min, and a mixing time of the high-speed mixer is set to 10 min, thereby obtaining mixture 5 #. (2) The aforementioned mixture 5 #and the modified distiller's grains 1 #are placed into hoppers of different automatic loss-in-weight feeders. Feeding parameters of the different automatic loss-in-weight feeders are set according to a weight ratio of the mixture 5 #(wt %) to the modified distiller's grains 1 #(wt %) of 70:30. Then a mixture composed of the mixture 5 #and the modified distiller's grains 1 #is extruded through a twin-screw extruder, followed by stranding, cooling, and pelletizing to obtain pellets. The resulting pellets are thoroughly dried to obtain distiller's grains-based fully biodegradable green composite material 17 #. During this processing, a temperature of the twin-screw extruder is set to 180° C., and a rotation speed of main engine of the twin-screw extruder is set to 300 rpm.

### Embodiment 18

### Preparation of Modified Distiller's Grains: As Described in the Embodiment 1, Modified Distiller's Grains 1 #is Obtained and Set Aside for Later Use.

Preparation of distiller's grains-based fully biodegradable green composite material: (1) Biodegradable polyester PBS is placed in a drying apparatus for thorough drying. After drying, PBS (67.6 wt %), chain extender epoxy-functionalized styrene-acrylate copolymer Bio-Master™ HPC-3510P (purchased from Fine-Blend Polymer (Shanghai) Co., Ltd.) (0.7 wt %), anti-hydrolysis agent monomeric carbodiimide (1.0 wt %), thermal stabilizer 330 (commonly known as 1,3,5-trimethyl-2,4,6-tris(3,5-di-tert-butyl-4-hydroxybenzyl)benzene) (0.2 wt %), thermal stabilizer 636 (commonly known as bis(2,6-di-tert-butyl-4-methylphenyl) pentaerythritol diphosphate) (0.2 wt %), and lubricant octacosanoic acid (0.3 wt %) are weighed according to the aforementioned weight percentages and added to a high-speed mixer. A temperature of the high-speed mixer is set to room temperature, a rotational speed of the high-speed mixer is set to 1,000 rad/min, and a mixing time of the high-speed mixer is set to 10 min, thereby obtaining mixture 6 #. (2) The aforementioned mixture 6 #and the modified distiller's grains 1 #are placed into hoppers of different automatic loss-in-weight feeders. Feeding parameters of the different automatic loss-in-weight feeders are set according to a weight ratio of the mixture 6 #(wt %) to the modified distiller's grains 1 #(wt %) of 70:30. Then a mixture composed of the mixture 6 #and the modified distiller's grains 1 #is extruded through a twin-screw extruder, followed by stranding, cooling, and pelletizing to obtain pellets. The resulting pellets are thoroughly dried to obtain distiller's grains-based fully biodegradable green composite material 18 #. During this processing, a temperature of the twin-screw extruder is set to 135° C., and a rotation speed of main engine of the twin-screw extruder is set to 300 rpm.

### Embodiment 19

### Preparation of Modified Distiller's Grains: As Described in the Embodiment 1, Modified Distiller's Grains 1 #is Obtained and Set Aside for Later Use.

Preparation of distiller's grains-based fully biodegradable green composite material: (1) Biodegradable polyester PHBV is placed in a drying apparatus for thorough drying. After drying, PHBV (63.5 wt %), chain extender epoxy-functionalized styrene-acrylate copolymer Relysorb® 4400 (purchased from Relyon New Materials Co., Ltd.) (0.7 wt %), anti-hydrolysis agent monomeric carbodiimide (0.1 wt %), thermal stabilizer 1098 (commonly known as N,N′-Bis-(3-(3,5-di-tert-butyl-4-hydroxyphenyl) propionyl) hexanediamine and purchased from BASF Corporation) (0.2 wt %), thermal stabilizer 168 (0.2 wt %), and lubricant pentaerythritol stearate (0.3 wt %) are weighed according to the aforementioned weight percentages and added to a high-speed mixer. A temperature of the high-speed mixer is set to room temperature, a rotational speed of the high-speed mixer is set to 1,000 rad/min, and a mixing time of the high-speed mixer is set to 10 min, thereby obtaining mixture 7 #. (2) The aforementioned mixture 7 #and the modified distiller's grains 1 #are placed into hoppers of separate automatic loss-in-weight feeders. Feeding parameters of the separate automatic loss-in-weight feeders are set according to a weight ratio of the mixture 7 #(wt %) to the modified distiller's grains 1 #(wt %) of 65:35. Then a mixture composed of the mixture 7 #and the modified distiller's grains 1 #is extruded through a twin-screw extruder, followed by stranding, cooling, and pelletizing to obtain pellets. The resulting pellets are thoroughly dried to obtain distiller's grains-based fully biodegradable green composite material 19 #. During this processing, a temperature of the twin-screw extruder is set to 200° C., and a rotation speed of main engine of the twin-screw extruder is set to 300 rpm.

### Embodiment 20

### Preparation of Modified Distiller's Grains: As Described in the Embodiment 1, Modified Distiller's Grains 1 #is Obtained and Set Aside for Later Use.

Preparation of distiller's grains-based fully biodegradable green composite material: (1) Biodegradable polyester PGA is placed in a drying apparatus for thorough drying. After drying, PGA (85 wt %), chain extender epoxy-functionalized styrene-acrylate copolymer Joncryl® 4400 (purchased from BASF Corporation) (5.05 wt %), anti-hydrolysis agent monomeric carbodiimide (3.3 wt %), thermal stabilizer 245 (commonly known as ethylene bis(oxyethylene) bis-(3-(5-tert-butyl-4-hydroxy-m-tolyl) propionate) and purchased from BASF Corporation) (1 wt %), thermal stabilizer 626 (commonly known as bis(2,4-di-tert-butylphenyl) pentaerythritol diphosphate and purchased from RIANLON CORPORATION) (1 wt %), and lubricant zinc stearate (0.1 wt %) are weighed according to the aforementioned weight percentages and added to a high-speed mixer. A temperature of the high-speed mixer is set to room temperature, a rotational speed of the high-speed mixer is set to 100 rad/min, and a mixing time of the high-speed mixer is set to 15 min, thereby obtaining mixture 8 #. (2) The aforementioned mixture 8 #and the modified distiller's grains 1 #are placed into hoppers of separate automatic loss-in-weight feeders. Feeding parameters of the separate automatic loss-in-weight feeders are set according to a weight ratio of the mixture 8 #(wt %) to the modified distiller's grains 1 #(wt %) of 95:5. Then a mixture composed of the mixture 8 #and the modified distiller's grains 1 #is extruded through a twin-screw extruder, followed by stranding, cooling, and pelletizing to obtain pellets. The resulting pellets are thoroughly dried to obtain distiller's grains-based fully biodegradable green composite material 20 #. During this processing, a temperature of the twin-screw extruder is set to 250° C., and a rotation speed of main engine of the twin-screw extruder is set to 100 rpm.

### Embodiment 21

### Preparation of Modified Distiller's Grains: As Described in the Embodiment 1, Modified Distiller's Grains 1 #is Obtained and Set Aside for Later Use.

Preparation of distiller's grains-based fully biodegradable green composite material: (1) Biodegradable polyester PLC is placed in a drying apparatus for thorough drying. After drying, PLC (25 wt %), chain extender epoxy-functionalized styrene copolymer Eco-Batch™ ECO-1120 (purchased from Fine-Blend Polymer (Shanghai) Co., Ltd.) (2.3 wt %), anti-hydrolysis agent monomeric carbodiimide (5.05 wt %), thermal stabilizer N,N′-diphenylthiourea (DPT) (0.05 wt %), thermal stabilizer 1790 (commonly known as 1,3,5-tri(4-tert-butyl-3-hydroxy-2,6-dimethylbenzyl)-1,3,5-triazine-2,4,6-(1H,3H,5H)-trione and purchased from RIANLON CORPORATION) (0.05 wt %), and lubricant polysiloxane (2.55 wt %) are weighed according to the aforementioned weight percentages and added to a high-speed mixer. A temperature of the high-speed mixer is set to room temperature, a rotational speed of the high-speed mixer is set to 2,000 rad/min, and a mixing time of the high-speed mixer is set to 5 min, thereby obtaining mixture 9 #. (2) The aforementioned mixture 9 #and the modified distiller's grains 1 #are placed into different of separate automatic loss-in-weight feeders separately. Feeding parameters of the different automatic loss-in-weight feeders are set according to a weight ratio of the mixture 9 #(wt %) to the modified distiller's grains 1 #(wt %) of 35:65. Then a mixture composed of the mixture 9 #and the modified distiller's grains 1 #is extruded through a twin-screw extruder, followed by stranding, cooling, and pelletizing to obtain pellets. The resulting pellets are thoroughly dried to obtain distiller's grains-based fully biodegradable green composite material 21 #. During this processing, a temperature of the twin-screw extruder is set to 100° C., and a rotation speed of main engine of the twin-screw extruder is set to 400 rpm.

### Embodiment 22

### Preparation of Modified Distiller's Grains: As Described in the Embodiment 1, Modified Distiller's Grains 1 #is Obtained and Set Aside for Later Use.

Preparation of distiller's grains-based fully biodegradable green composite material: (1) Biodegradable polyester PBAT is placed in a drying apparatus for thorough drying. After drying, PBAT (55 wt %), chain extender Bio-Master™ GS-20 (commonly known as epoxy type random copolymer and purchased from Fine-Blend Polymer (Shanghai) Co., Ltd.) (10 wt %), anti-hydrolysis agent polycarbodiimide (10 wt %), thermal stabilizer 5067 (commonly known as nonyl-N-(nonylphenyl) aniline) (1.5 wt %), thermal stabilizer 168 (1.5 wt %), and lubricant stearic acid (5 wt %) are weighed according to the aforementioned weight percentages and added to a high-speed mixer. A temperature of the high-speed mixer is set to room temperature, a rotational speed of the high-speed mixer is set to 1,050 rad/min, and a mixing time of the high-speed mixer is set to 10 min, thereby obtaining mixture 10 #. (2) The aforementioned mixture 10 #and the modified distiller's grains 1 #are placed into hoppers of separate automatic loss-in-weight feeders. Feeding parameters of the separate automatic loss-in-weight feeders are set according to a weight ratio of the mixture 10 #(wt %) to the modified distiller's grains 1 #(wt %) of 83:17. Then a mixture composed of the mixture 10 #and the modified distiller's grains 1 #is extruded through a twin-screw extruder, followed by stranding, cooling, and pelletizing to obtain pellets. The resulting pellets are thoroughly dried to obtain distiller's grains-based fully biodegradable green composite material 22 #. During this processing, a temperature of the twin-screw extruder is set to 180° C., and a rotation speed of main engine of the twin-screw extruder is set to 250 rpm.

### Comparative Embodiment 1

Biodegradable polyesters PBAT and PLA are placed in drying apparatuses separately for thorough drying. After drying, PBAT (68.04 wt %) and PLA (0.7 wt %), along with chain extender Joncryl® ADR 4468 (0.8 wt %), anti-hydrolysis agent polycarbodiimide (1.4 wt %), thermal stabilizer 1010 (0.2 wt %), thermal stabilizer 168 (0.2 wt %), and lubricant erucamide (0.3 wt %) are weighed according to the aforementioned weight percentages and added to a high-speed mixer. A temperature of the high-speed mixer is set to room temperature, a rotational speed of the high-speed mixer is set to 1,000 rad/min, and a mixing time of the high-speed mixer is set to 10 min, thereby obtaining a mixture. The resulting mixture is placed into a hopper of an automatic loss-in-weight feeder, and feeding parameters of the automatic loss-in-weight feeder are set. A composite material required for the comparative embodiment 1 is prepared through extrusion, stranding, cooling, and pelletizing by using a twin-screw extruder. The resulting pellets are thoroughly dried to obtain the composite material required for the comparative embodiment 1, which is marked as composite material A. During this processing, a temperature of the twin-screw extruder is set to 180° C., and a rotation speed of main engine of the twin-screw extruder is set to 300 rpm.

### Comparative Embodiment 2

Preparation of modified distiller's grains: Distiller's grains from Chinese liquor are crushed, thoroughly washed in water, filtered to remove water, and then dried in a drying oven at 100° C. to remove moisture to obtain dried distiller's grains. The dried distiller's grains are then ground in a mill and sieved to a particle size of 1,250 mesh to obtain distiller's grains powder, which is marked as modified distiller's grains B.

Preparation of composite material: (1) as described in the embodiment 2, mixture 2 #is obtained. (2) The mixture 2 #and the modified distiller's grains B are separately placed into hoppers of different automatic loss-in-weight feeders. Feeding parameters of the automatic loss-in-weight feeders are set according to a weight ratio of the mixture 2 #(wt %) to the modified distiller's grains B (wt %) of 70:30. Then a mixture composed of the mixture 2 #and the modified distiller's grains B is extruded through a twin-screw extruder, followed by stranding, cooling, and pelletizing to obtain pellets. The resulting pellets are thoroughly dried to obtain composite material B. During this processing, a temperature of the twin-screw extruder is set to 180° C., and a rotation speed of main engine of the twin-screw extruder is set to 300 rpm.

### Comparative Embodiment 3

Preparation of modified distiller's grains: Distiller's grains from Chinese liquor are crushed, thoroughly washed in water, filtered to remove water, and then dried in a drying oven at 100° C. to remove moisture to obtain dried distiller's grains. The dried distiller's grains are then ground in a mill and sieved to a particle size of 1,250 mesh to obtain distiller's grains powder. The distiller's grains powder is added to a high-speed mixer, a rotational speed of the high-speed mixer is set to 1,000 rad/min, and a temperature of the high-speed mixer is raised to 100° C. Under high-speed stirring, coupling agent KH560 is gradually added to the high-speed mixer containing the distiller's grains powder while stirring, in a weight ratio of the distiller's grains powder (wt %) to the coupling agent (wt %) of 25:1. After the addition is completed, a material temperature is controlled at 100° C. with stirring for 30 min to obtain a mixture. After the subsequent reaction is complete, heating is stopped. The mixture is cooled to room temperature with stirring at a low speed of 100 rpm to obtain KH560-treated distiller's grains powder, which is marked as modified distiller's grains D.

Preparation of composite material: (1) as described in the embodiment 2, mixture 2 #is obtained. (2) The mixture 2 #and the modified distiller's grains C are separately placed into hoppers of different automatic loss-in-weight feeders. Feeding parameters of the automatic loss-in-weight feeders are set according to a weight ratio of the mixture 2 #(wt %) to the modified distiller's grains C (wt %) of 70:30. Then a mixture composed of the mixture 2 #and the modified distiller's grains C is extruded through a twin-screw extruder, followed by stranding, cooling, and pelletizing to obtain pellets. The resulting pellets are thoroughly dried to obtain composite material C. During this processing, a temperature of the twin-screw extruder is set to 180° C., and a rotation speed of main engine of the twin-screw extruder is set to 300 rpm.

### Comparative Embodiment 4

Preparation of modified distiller's grains: Distiller's grains from Chinese liquor are crushed, thoroughly washed in water, filtered to remove water, and then dried in a drying oven at 100° C. to remove moisture to obtain dried distiller's grains. The dried distiller's grains are then ground in a mill and sieved to a particle size of 1,250 mesh to obtain distiller's grains powder. The distiller's grains powder is added to a high-speed mixer, a rotational speed of the high-speed mixer is set to 1,000 rad/min, and a temperature of the high-speed mixer is raised to 100° C. Under high-speed stirring, coupling agent KH550 is gradually added to the high-speed mixer containing the distiller's grains powder while stirring, in a weight ratio of the distiller's grains powder (wt %) to the coupling agent (wt %) of 25:1. After the addition is completed, a material temperature is controlled at 100° C. with stirring for 30 min to obtain a mixture. After the subsequent reaction is complete, heating is stopped. The mixture is cooled to room temperature with stirring at a low speed of 100 rpm to obtain KH550-treated distiller's grains powder, which is marked as modified distiller's grains D.

Preparation of composite material: (1) as described in the embodiment 2, mixture 2 #is obtained. (2) The mixture 2 #and the modified distiller's grains D are separately placed into hoppers of different automatic loss-in-weight feeders. Feeding parameters of the automatic loss-in-weight feeders are set according to a weight ratio of the mixture 2 #(wt %) to the modified distiller's grains D (wt %) of 70:30. Then a mixture composed of the mixture 2 #and the modified distiller's grains D is extruded through a twin-screw extruder, followed by stranding, cooling, and pelletizing to obtain pellets. The resulting pellets are thoroughly dried to obtain composite material D. During this processing, a temperature of the twin-screw extruder is set to 180° C., and a rotation speed of main engine of the twin-screw extruder is set to 300 rpm.

### Comparative Embodiment 5

Preparation of modified distiller's grains: Distiller's grains from Chinese liquor are crushed, thoroughly washed in water, filtered to remove water, and then dried in a drying oven at 100° C. to remove moisture to obtain dried distiller's grains. The dried distiller's grains are then ground in a mill and sieved to a particle size of 1,250 mesh to obtain distiller's grains powder. The distiller's grains powder is added to a high-speed mixer, a rotational speed of the high-speed mixer is set to 1,000 rad/min, and a temperature of the high-speed mixer is raised to 100° C. Under high-speed stirring, coupling agent NDZ-201 is gradually added to the high-speed mixer containing the distiller's grains powder while stirring, in a weight ratio of the distiller's grains powder (wt %) to the coupling agent (wt %) of 25:1. After the addition is completed, a material temperature is controlled at 100° C. with stirring for 30 min to obtain a mixture. After the subsequent reaction is complete, heating is stopped. The mixture is cooled to room temperature with stirring at a low speed of 100 rpm to obtain NDZ-201-treated distiller's grains powder, which is marked as modified distiller's grains E.

Preparation of composite material: (1) as described in the embodiment 2, mixture 2 #is obtained. (2) The mixture 2 #and the modified distiller's grains E are separately placed into hoppers of different automatic loss-in-weight feeders. Feeding parameters of the automatic loss-in-weight feeders are set according to a weight ratio of the mixture 2 #(wt %) to the modified distiller's grains E (wt %) of 70:30. Then a mixture composed of the mixture 2 #and the modified distiller's grains E is extruded through a twin-screw extruder, followed by stranding, cooling, and pelletizing to obtain pellets. The resulting pellets are thoroughly dried to obtain composite material E. During this processing, a temperature of the twin-screw extruder is set to 180° C., and a rotation speed of main engine of the twin-screw extruder is set to 300 rpm.

### Comparative Embodiment 6

Preparation of modified distiller's grains: Distiller's grains from Chinese liquor are crushed, thoroughly washed in water, filtered to remove water, and then dried in a drying oven at 100° C. to remove moisture to obtain dried distiller's grains. The dried distiller's grains are then ground in a mill and sieved to a particle size of 1,250 mesh to obtain distiller's grains powder. The distiller's grains powder is added to a high-speed mixer, a rotational speed of the high-speed mixer is set to 1,000 rad/min, and a temperature of the high-speed mixer is raised to 100° C. Under high-speed stirring, carboxyl-terminated hyperbranched polyester Hyper C304 is gradually added to the high-speed mixer containing the distiller's grains powder while stirring, in a weight ratio of the distiller's grains powder (wt %) to the hyperbranched resin (wt %) of 25:1. After the addition is completed, a material temperature is controlled at 100° C. with stirring for 30 min to obtain a mixture. After the subsequent reaction is complete, heating is stopped. The mixture is cooled to room temperature with stirring at a low speed of 100 rpm to obtain Hyper C304-treated distiller's grains powder, which is marked as modified distiller's grains F.

Preparation of composite material: (1) as described in the embodiment 2, mixture 2 #is obtained. (2) The mixture 2 #and the modified distiller's grains F are separately placed into hoppers of different automatic loss-in-weight feeders. Feeding parameters of the automatic loss-in-weight feeders are set according to a weight ratio of the mixture 2 #(wt %) to the modified distiller's grains F (wt %) of 70:30. Then a mixture composed of the mixture 2 #and the modified distiller's grains F is extruded through a twin-screw extruder, followed by stranding, cooling, and pelletizing to obtain pellets. The resulting pellets are thoroughly dried to obtain composite material F. During this processing, a temperature of the twin-screw extruder is set to 180° C., and a rotation speed of main engine of the twin-screw extruder is set to 300 rpm.

### Comparative Embodiment 7

Preparation of modified distiller's grains: Distiller's grains from Chinese liquor are crushed, thoroughly washed in water, filtered to remove water, and then dried in a drying oven at 100° C. to remove moisture to obtain dried distiller's grains. The dried distiller's grains are then ground in a mill and sieved to a particle size of 1,250 mesh to obtain distiller's grains powder. The distiller's grains powder is added to a high-speed mixer, a rotational speed of the high-speed mixer is set to 1,000 rad/min, and a temperature of the high-speed mixer is raised to 100° C. Under high-speed stirring, hyperbranched epoxy resin Hyper E102 is gradually added to the high-speed mixer containing the distiller's grains powder while stirring, in a weight ratio of the distiller's grains powder (wt %) to the hyperbranched resin (wt %) of 25:1. After the addition is completed, a material temperature is controlled at 100° C. with stirring for 30 min to obtain a mixture. After the subsequent reaction is complete, heating is stopped. The mixture is cooled to room temperature with stirring at a low speed of 100 rpm to obtain Hyper E102-treated distiller's grains powder, which is marked as modified distiller's grains G.

Preparation of composite material: (1) as described in the embodiment 2, mixture 2 #is obtained. (2) The mixture 2 #and the modified distiller's grains G are separately placed into hoppers of different automatic loss-in-weight feeders. Feeding parameters of the automatic loss-in-weight feeders are set according to a weight ratio of the mixture 2 #(wt %) to the modified distiller's grains G (wt %) of 70:30. Then a mixture composed of the mixture 2 #and the modified distiller's grains G is extruded through a twin-screw extruder, followed by stranding, cooling, and pelletizing to obtain pellets. The resulting pellets are thoroughly dried to obtain composite material G. During this processing, a temperature of the twin-screw extruder is set to 180° C., and a rotation speed of main engine of the twin-screw extruder is set to 300 rpm.

### Comparative Embodiment 8

Preparation of modified distiller's grains: Distiller's grains from Chinese liquor are crushed, thoroughly washed in water, filtered to remove water, and then dried in a drying oven at 100° C. to remove moisture to obtain dried distiller's grains. The dried distiller's grains are then ground in a mill and sieved to a particle size of 1,250 mesh to obtain distiller's grains powder. The distiller's grains powder is added to a high-speed mixer, a rotational speed of the high-speed mixer is set to 1,000 rad/min, and a temperature of the high-speed mixer is raised to 100° C. Under high-speed stirring, carboxyl-terminated hyperbranched polyester Hyper C181 is gradually added to the high-speed mixer containing the distiller's grains powder while stirring, in a weight ratio of the distiller's grains powder (wt %) to the hyperbranched resin (wt %) of 25:1. After the addition is completed, a material temperature is controlled at 100° C. with stirring for 30 min to obtain a mixture. After the subsequent reaction is complete, heating is stopped. The mixture is cooled to room temperature with stirring at a low speed of 100 rpm to obtain Hyper C181-treated distiller's grains powder, which is marked as modified distiller's grains H.

Preparation of composite material: (1) as described in the embodiment 2, mixture 2 #is obtained. (2) The mixture 2 #and the modified distiller's grains H are separately placed into hoppers of different automatic loss-in-weight feeders. Feeding parameters of the automatic loss-in-weight feeders are set according to a weight ratio of the mixture 2 #(wt %) to the modified distiller's grains H (wt %) of 70:30. Then a mixture composed of the mixture 2 #and the modified distiller's grains H is extruded through a twin-screw extruder, followed by stranding, cooling, and pelletizing to obtain pellets. The resulting pellets are thoroughly dried to obtain composite material H. During this processing, a temperature of the twin-screw extruder is set to 180° C., and a rotation speed of main engine of the twin-screw extruder is set to 300 rpm.

### Comparative Embodiment 9

Preparation of modified distiller's grains: Distiller's grains from Chinese liquor are crushed, thoroughly washed in water, filtered to remove water, and then dried in a drying oven at 100° C. to remove moisture to obtain dried distiller's grains. The dried distiller's grains are then ground in a mill and sieved to a particle size of 1,250 mesh to obtain distiller's grains powder. The distiller's grains powder is added to a high-speed mixer, a rotational speed of the high-speed mixer is set to 1,000 rad/min, and a temperature of the high-speed mixer is raised to 100° C. Under high-speed stirring, amino-terminated hyperbranched polyester Amine Functional Boltorn™ H40 is gradually added to the high-speed mixer containing the distiller's grains powder while stirring, in a weight ratio of the distiller's grains powder (wt %) to the hyperbranched resin (wt %) of 25:1. After the addition is completed, a material temperature is controlled at 100° C. with stirring for 30 min to obtain a mixture. After the subsequent reaction is complete, heating is stopped. The mixture is cooled to room temperature with stirring at a low speed of 100 rpm to obtain Hyper Amine Functional Boltorn™ H40-treated distiller's grains powder, which is marked as modified distiller's grains I.

Preparation of composite material: (1) as described in the embodiment 2, mixture 2 #is obtained. (2) The mixture 2 #and the modified distiller's grains I are separately placed into hoppers of different automatic loss-in-weight feeders. Feeding parameters of the automatic loss-in-weight feeders are set according to a weight ratio of the mixture 2 #(wt %) to the modified distiller's grains I (wt %) of 70:30. Then a mixture composed of the mixture 2 #and the modified distiller's grains I is extruded through a twin-screw extruder, followed by stranding, cooling, and pelletizing to obtain pellets. The resulting pellets are thoroughly dried to obtain composite material I. During this processing, a temperature of the twin-screw extruder is set to 180° C., and a rotation speed of main engine of the twin-screw extruder is set to 300 rpm.

### Comparative Embodiment 10

Preparation of modified distiller's grains: Distiller's grains from Chinese liquor are crushed, thoroughly washed in water, filtered to remove water, and then dried in a drying oven at 100° C. to remove moisture to obtain dried distiller's grains. The dried distiller's grains are then ground in a mill and sieved to a particle size of 1,250 mesh to obtain distiller's grains powder. The distiller's grains powder is added to a high-speed mixer, a rotational speed of the high-speed mixer is set to 1,000 rad/min, and a temperature of the high-speed mixer is raised to 100° C. Under high-speed stirring, hydroxyl-terminated hyperbranched polyester Boltorn™ Regular H40 is gradually added to the high-speed mixer containing the distiller's grains powder while stirring, in a weight ratio of the distiller's grains powder (wt %) to the hyperbranched resin (wt %) of 25:1. After the addition is completed, a material temperature is controlled at 100° C. with stirring for 30 min to obtain a mixture. After the subsequent reaction is complete, heating is stopped. The mixture is cooled to room temperature with stirring at a low speed of 100 rpm to obtain Boltorn™ Regular H40-treated distiller's grains powder, which is marked as modified distiller's grains J.

Preparation of composite material: (1) as described in the embodiment 2, mixture 2 #is obtained. (2) The mixture 2 #and the modified distiller's grains J are separately placed into hoppers of different automatic loss-in-weight feeders. Feeding parameters of the automatic loss-in-weight feeders are set according to a weight ratio of the mixture 2 #(wt %) to the modified distiller's grains J (wt %) of 70:30. Then a mixture composed of the mixture 2 #and the modified distiller's grains J is extruded through a twin-screw extruder, followed by stranding, cooling, and pelletizing to obtain pellets. The resulting pellets are thoroughly dried to obtain composite material J. During this processing, a temperature of the twin-screw extruder is set to 180° C., and a rotation speed of main engine of the twin-screw extruder is set to 300 rpm.

### Comparative Embodiment 11

Preparation of modified distiller's grains: (1) Distiller's grains from Chinese liquor are crushed, thoroughly washed in water, filtered to remove water, and then dried in a drying oven at 100° C. to remove moisture to obtain dried distiller's grains. The dried distiller's grains are then ground in a mill and sieved to a particle size of 1,250 mesh to obtain distiller's grains powder. The distiller's grains powder is added to a high-speed mixer, a rotational speed of the high-speed mixer is set to 1,000 rad/min, and a temperature of the high-speed mixer is raised to 100° C. Under high-speed stirring, carboxyl-terminated hyperbranched polyester Hyper C304 is gradually added to the high-speed mixer containing the distiller's grains powder while stirring, in a weight ratio of the distiller's grains powder (wt %) to the hyperbranched resin (wt %) of 50:1. After the addition is completed, a material temperature is controlled at 100° C. with stirring for 30 min to obtain Hyper C304-treated distiller's grains powder. (2) Subsequently, coupling agent KH560 is added to the high-speed mixer containing the Hyper C304-treated distiller's grains powder prepared above to obtain a mixture in a weight ratio of the distiller's grains powder (wt %) to the coupling agent (wt %) of 50:1. The rotational speed of the high-speed mixer is set to 1,000 rad/min, and the material temperature is controlled at 100° C. with stirring for 30 min. After completion, heating is stopped, and the mixture is cooled to room temperature with stirring at a low speed of 100 rpm to obtain jointly modified distiller's grains treated with Hyper C304 and KH560, which is marked as modified distiller's grains K and set aside for later use.

Preparation of composite material: (1) as described in the embodiment 2, mixture 2 #is obtained. (2) The mixture 2 #and the modified distiller's grains K are separately placed into hoppers of different automatic loss-in-weight feeders. Feeding parameters of the automatic loss-in-weight feeders are set according to a weight ratio of the mixture 2 #(wt %) to the modified distiller's grains K (wt %) of 70:30. Then a mixture composed of the mixture 2 #and the modified distiller's grains K is extruded through a twin-screw extruder, followed by stranding, cooling, and pelletizing to obtain pellets. The resulting pellets are thoroughly dried to obtain composite material K. During this processing, a temperature of the twin-screw extruder is set to 180° C., and a rotation speed of main engine of the twin-screw extruder is set to 300 rpm.

In practical applications, the distiller's grains-based fully biodegradable green composite material prepared by the disclosure, when used in film products, plays a crucial role in the strength of the film during the packaging or handling of goods. It ensures the integrity and usability of the film and has strong guiding significance for the application of various types of products. A purpose of the disclosure is to propose a low-cost, distiller's grains-based fully biodegradable green composite material that also possesses good mechanical properties. To this end, all film samples are subjected to tensile testing by using a universal material testing machine to verify their mechanical properties. In addition, water vapor transmission rates of the film examples are also tested to validate their barrier properties. The composite materials obtained from the embodiments 1-22 and the comparative embodiments 1-11 of the disclosure are prepared into films for testing in accordance with the GB/T 35795-2017 standard. The performance test results are listed in Table 1.

TABLE 1
performance test results of embodiments 1-22 and comparative embodiments 1-11

| | performance | | | | | |
|---|---|---|---|---|---|---|
| | | | | | | Water vapor |
| | | | | | | transmission |
| | | Tensile strength | | | | rate (gram per |
| | Thickness | (megapascal | | Elongation at | | square meter |
| | (millimeter (mm)) | (MPa)) | | break (%) | | per 24 hours |
| serial number | 0.01 ≤ d ≤ 0.015 mm | Lateral | Axial | Lateral | Axial | g/(m² · 24 h)) |
| Embodiment 1 | 0.01 ≤ d ≤ 0.015 mm | 30.1 | 33.2 | 362.7 | 396.6 | 568.3 |
| Embodiment 2 | 0.01 ≤ d ≤ 0.015 mm | 39.5 | 43.2 | 348.7 | 377.8 | 377.6 |
| Embodiment 3 | 0.01 ≤ d ≤ 0.015 mm | 29.4 | 31.2 | 248.9 | 276.4 | 445.7 |
| Embodiment 4 | 0.01 ≤ d ≤ 0.015 mm | 17.7 | 19.5 | 87.1 | 96.4 | 978.4 |
| Embodiment 5 | 0.01 ≤ d ≤ 0.015 mm | 38.4 | 41.2 | 328.9 | 387.5 | 373.4 |
| Embodiment 6 | 0.01 ≤ d ≤ 0.015 mm | 35.9 | 39.6 | 318.1 | 353.4 | 346.2 |
| Embodiment 7 | 0.01 ≤ d ≤ 0.015 mm | 36.5 | 39.9 | 320.5 | 367.6 | 356.7 |
| Embodiment 8 | 0.01 ≤ d ≤ 0.015 mm | 36.2 | 39.8 | 320.3 | 356.7 | 353.4 |
| Embodiment 9 | 0.01 ≤ d ≤ 0.015 mm | 36.9 | 40.2 | 323.4 | 373.4 | 367.4 |
| Embodiment 10 | 0.01 ≤ d ≤ 0.015 mm | 35.1 | 38.3 | 317.1 | 346.6 | 342.3 |
| Embodiment 11 | 0.01 ≤ d ≤ 0.015 mm | 34.6 | 37.1 | 313.2 | 320.5 | 334.2 |
| Embodiment 12 | 0.01 ≤ d ≤ 0.015 mm | 33.4 | 36.4 | 312.4 | 334.2 | 286.7 |
| Embodiment 13 | 0.01 ≤ d ≤ 0.015 mm | 30.7 | 32.1 | 343.5 | 387.4 | 576.2 |
| Embodiment 14 | 0.01 ≤ d ≤ 0.015 mm | 28.7 | 30.2 | 219.7 | 249.1 | 545.7 |
| Embodiment 15 | 0.01 ≤ d ≤ 0.015 mm | 38.4 | 42.1 | 347.6 | 396.6 | 376.6 |
| Embodiment 16 | 0.01 ≤ d ≤ 0.015 mm | 38.3 | 41.9 | 346.8 | 395.6 | 373.1 |
| Embodiment 17 | 0.01 ≤ d ≤ 0.015 mm | 15.7 | 16.5 | 487.6 | 496.3 | 478.4 |
| Embodiment 18 | 0.01 ≤ d ≤ 0.015 mm | 35.2 | 37.7 | 131.4 | 145.9 | 408.9 |
| Embodiment 19 | 0.01 ≤ d ≤ 0.015 mm | 43.8 | 46.7 | 3.5 | 4.8 | 256.7 |
| Embodiment 20 | 0.01 ≤ d ≤ 0.015 mm | 84.6 | 87.9 | 7.6 | 8.9 | 278.1 |
| Embodiment 21 | 0.01 ≤ d ≤ 0.015 mm | 21.8 | 28.2 | 307.8 | 338.7 | 606.9 |
| Embodiment 22 | 0.01 ≤ d ≤ 0.015 mm | 19.2 | 22.1 | 147.6 | 165.4 | 845.7 |
| Comparative | 0.01 ≤ d ≤ 0.015 mm | 16.3 | 17.8 | 152.3 | 162.9 | 1164.8 |
| embodiment 1 | | | | | | |
| Comparative | 0.01 ≤ d ≤ 0.015 mm | 21.7 | 24.7 | 203.1 | 217.2 | 931.8 |
| embodiment 2 | | | | | | |
| Comparative | 0.01 ≤ d ≤ 0.015 mm | 26.7 | 29.1 | 249.9 | 267.4 | 684.6 |
| embodiment 3 | | | | | | |
| Comparative | 0.01 ≤ d ≤ 0.015 mm | 25.1 | 27.3 | 234.3 | 250.7 | 931.8 |
| embodiment 4 | | | | | | |
| Comparative | 0.01 ≤ d ≤ 0.015 mm | 26.4 | 27.8 | 234.9 | 240.4 | 716.8 |
| embodiment 5 | | | | | | |
| Comparative | 0.01 ≤ d ≤ 0.015 mm | 29.8 | 32.6 | 269.5 | 294.6 | 445.7 |
| embodiment 6 | | | | | | |
| Comparative | 0.01 ≤ d ≤ 0.015 mm | 29.5 | 32.2 | 258.7 | 298.7 | 519.3 |
| embodiment 7 | | | | | | |
| Comparative | 0.01 ≤ d ≤ 0.015 mm | 29.2 | 31.8 | 256.2 | 285.4 | 530.1 |
| embodiment 8 | | | | | | |
| Comparative | 0.01 ≤ d ≤ 0.015 mm | 28.7 | 31.7 | 254.5 | 282.7 | 551.1 |
| embodiment 9 | | | | | | |
| Comparative | 0.01 ≤ d ≤ 0.015 mm | 28.1 | 30.6 | 253.7 | 277.3 | 668.4 |
| embodiment 10 | | | | | | |
| Comparative | 0.01 ≤ d ≤ 0.015 mm | 31.5 | 33.4 | 276.5 | 291.4 | 577.6 |
| embodiment 11 | | | | | | |

### (1) Analysis of the Test Results for the Comparative Embodiment 1 and the Embodiments 1-4 is as Follows.

The comparative embodiment 1 is a resin material without distiller's grains. As shown by the comparative embodiment 1 and the embodiments 1-4, the tensile strength initially increases and then decreases with increasing content of the modified distiller's grains. Specifically, in the embodiment 2, when the content of the modified distiller's grains is 30 wt %, the tensile strength reaches a maximum value. Compared with the comparative embodiment 1, the transverse and longitudinal (i.e., the lateral and axial) tensile strengths in the embodiment 2 increase by 142.3% and 151.16%, respectively. The elongation at break also exhibits an initial increase followed by a decrease with the increasing content of the modified distiller's grains. The improvement in elongation at break is attributed to a role of the coupling agent and the hyperbranched resin as compatibilizers during modification and blending process, which increase a molecular chain length between the distiller's grains powder and the biodegradable resin matrix, thereby forming a flexible interface and enhancing the elongation at break of the composite material. However, when the content of the distiller's grains powder is excessively high, the decline in elongation at break may due to agglomeration and poor dispersion of the distiller's grains powder. The water vapor transmission rate initially decreases and then increases with the increasing content of the modified distiller's grains, reaching its minimum value in the embodiment 2. Therefore, conclusions are drawn as follows. First, modified distiller's grains can improve the tensile strength of the composite material. However, when the content of the modified distiller's grains reaches 40 wt % and 50 wt %, the tensile strength begins to decline. The enhancement in tensile strength is due to the improved interfacial strength between the distiller's grains powder and the biodegradable resin achieved through joint modification with the coupling agent and the hyperbranched polyester, thereby increasing the tensile strength. The subsequent decline in tensile strength with higher distiller's grains powder content may be related to partial agglomeration and uneven dispersion of the distiller's grains powder in the biodegradable polyester. Nevertheless, the tensile strengths of the composite materials with 40 wt % (embodiment 3) and 50 wt % (embodiment 4) modified distiller's grains remain higher than that of the comparative embodiment 1. Provided that the performance and strength requirements of the product are met, the content of the distiller's grains powder can be increased to 50 wt %, thereby providing data support for large-scale and rapid consumption of the distiller's grains. Second, the increase in the modified distiller's grains content enhances the elongation at break of the composite material, but an excessively high content of the distiller's grains powder is detrimental to the elongation at break, which may limit application in situations requiring a higher elongation at break. Third, the water absorption rate increases at a high content of the distiller's grains powder (50 wt %), due to a fact that the distiller's grains powder is more hydrophilic than the resin.

### (2) Analysis of the Test Results for the Comparative Embodiment 2 and the Embodiment 2 is as Follows.

In the comparative embodiment 2, the distiller's grains added are not treated with the coupling agent and the hyperbranched resin, whereas in the embodiment 2, the distiller's grains powder is jointly treated with the coupling agent KH560 and the carboxyl-terminated hyperbranched polyester Hyper C304. The test data demonstrate that, compared to the comparative embodiment 2, the transverse and longitudinal tensile strengths of the embodiment 2 are increased by 82% and 74.9%, respectively, and the transverse and longitudinal elongation at break are also increased by 71.7% and 73.9%, respectively. The water absorption rate decreases from 931.8 g/(m²·24 h) to 377.6 g/(m²·24 h). It can be concluded that the joint treatment of the distiller's grains with the coupling agent KH560 and the carboxyl-terminated hyperbranched polyester significantly improves the performance of the composite material.

(3) Comparative Analysis of the Test Results for Distiller's Grains Treated with a Combination of the Coupling Agent and the Hyperbranched Resin Versus Treated with Only the Coupling Agent or Only the Hyperbranched Resin is as Follows.

In the comparative embodiments 3-5, the distiller's grains powder is treated with only the coupling agent without the use of the hyperbranched resin. The comparative embodiment 3 uses only the coupling agent KH560 for treatment and is compared with the embodiment 2, 5, 11, and 12. The comparative embodiment 4 uses only the coupling agent KH550 for treatment and is compared with the embodiments 6, 9, and 10. The comparative embodiment 5 uses only the coupling agent NDZ-201 for treatment and is compared with the embodiments 7 and 8.

In the comparative embodiments 6-10, the distiller's grains powder is treated with the hyperbranched resin only, without the use of the coupling agent. The comparative embodiment 6 uses only the carboxyl-terminated hyperbranched polyester Hyper C304 for treatment and is compared with the embodiments 2, 7, and 9. The comparative embodiment 7 uses only the hyperbranched epoxy Hyper E102 for treatment and is compared with the embodiment 6. The comparative embodiment 8 uses only the carboxyl-terminated hyperbranched polyester Hyper C181 and is compared with the embodiments 5, 8, and 10. The comparative embodiment 9 uses only the amino-terminated hyperbranched polyester Amine Functional Boltorn™ H40 and is compared with the embodiment 11. The comparative embodiment 10 uses only the hydroxyl-terminated hyperbranched polyester Boltorn™ Regular H40 and is compared with the embodiment 12.

Based on the test data from the above embodiments and the comparative embodiments, conclusions can be drawn as follows.

First, the performance of the composite materials obtained by filling the biodegradable polyester with the distiller's grains powder treated solely with the coupling agent or with the hyperbranched resin alone is lower than that of the composite materials obtained by treating the distiller's grains powder with a combination of both the coupling agent and the hyperbranched resin. Second, from the comparative embodiments 3-5, it can be concluded that among the coupling agents KH550, KH560, and NDZ-201, KH560 performs better than the other two. Third, from the comparative embodiments 6-9, it can be concluded that among the carboxyl-terminated hyperbranched polyester Hyper C304, the hyperbranched epoxy Hyper E102, the carboxyl-terminated hyperbranched polyester Hyper C181, the amino-terminated hyperbranched polyester Amine Functional Boltorn™ H40, and the hydroxyl-terminated hyperbranched polyester Boltorn™ Regular H40, the treatment with the carboxyl-terminated hyperbranched polyester Hyper C304 is superior to the other four. However, the performance differences in the biodegradable composite materials obtained from these five types of hyperbranched resins treated distiller's grains are not significant. This is due to the fact that the distiller's grains powder contains not only a large number of hydroxyl groups but also a wealth of active functional components, including alcohols, acids, aldehydes, esters, proteins, amino acids, active peptides, functional oligosaccharides, antioxidant phenols, and flavonoids. These active components can react well with the amino, hydroxyl, carboxyl, and epoxy groups of the hyperbranched resins, thereby providing good compatibility among the hyperbranched resins of different terminal group types, the distiller's grains powder, and the biodegradable resin, enhancing their interfacial strength, and improving performance.

(4) Analysis of the Test Results for the Distiller's Grains Powder Treated with Different Types of the Coupling Agents and the Hyperbranched Resins is as Follows.

First, in the embodiments 2, 7, and 9, the hyperbranched resin used is the carboxyl-terminated hyperbranched polyester Hyper C304. The difference lies in the coupling agent used: the embodiment 2 uses KH560, the embodiment 7 uses NDZ-201, and the embodiment 9 uses KH550. The performance test results indicate that the embodiment 2, which uses the KH560 and the carboxyl-terminated hyperbranched polyester Hyper C304, exhibits superior performance compared to the other two. Amino groups of the KH550, epoxy groups of the KH560, and hydroxyl groups of the NDZ-201 respectively react with the carboxyl end groups of the hyperbranched polyester. Specifically, the amino groups undergo an acid-base neutralization reaction with the carboxyl group, where the oxygen atom in the carboxyl group withdraws electrons through induction, reducing the electronegativity of the oxygen in the —OH group, weakening its bonding capacity to hydrogen, and leading to a dehydration reaction between the carboxyl group and the amino groups. The carboxy groups, acting as nucleophiles, attack the epoxy rings, leading to ring-opening and nucleophilic addition reactions. The reaction between the epoxy and carboxy groups generates ester bonds, which exhibit strong chemical binding forces. Due to the higher activation index of the KH560, the reaction products are relatively stable. Furthermore, the KH560 inherently possesses long alkyl chains, resulting in slightly greater cross-linking between the modified distiller's grains powder, the hyperbranched resin, and the biodegradable resin, as well as improved interfacial compatibility. Consequently, the modification effect achieved with the KH560 is superior to that of the biodegradable composite materials obtained by modifying the distiller's grains with the KH550 and the NDZ-201 in combination with the hyperbranched resin separately. These findings are consistent with the conclusion drawn in the second point of the aforementioned analysis (3). Similarly, the experimental results from the embodiments 5, 8, and 10 align with the above observations. It can be concluded that the KH560 is the preferred coupling agent among the three.

Second, in the embodiments 2, 5, 11, and 12, the coupling agent used is KH560, with the differences lying in the types of the hyperbranched resins used. Specifically, the embodiment 2 uses the carboxyl-terminated hyperbranched polyester Hyper C304. The embodiment 5 uses the carboxyl-terminated hyperbranched polyester Hyper C181. The embodiment 11 uses the amino-terminated hyperbranched polyester Amine Functional Boltorn™ H40. The embodiment 12 uses the hydroxyl-terminated hyperbranched polyester Boltorn™ Regular H40. Performance tests conducted on these four embodiments reveal that the embodiment, which uses the carboxyl-terminated hyperbranched polyester Hyper C304, exhibits the best performance. Consistent conclusions are also obtained in the embodiments 6, 9, and 10. This finding is in agreement with the third point from the aforementioned analysis (3). Therefore, it can be concluded that the carboxyl-terminated hyperbranched polyester Hyper C304 is the preferred choice for hyperbranched resins.

### (5) Analysis of the Test Results for the Embodiment 2 and the Comparative Embodiment 11 is as Follows.

In the embodiment 2, the distiller's grains are first treated with the coupling agent and then with the hyperbranched resin. In contrast, in the comparative embodiment 11, the order of treatment is reversed, with the distiller's grains first treated with the hyperbranched resin and then with the coupling agent. It can be observed that the performance of the comparative embodiment 11 is significantly lower than that of the embodiment 2. In the disclosure, the processing principle for the distiller's grains powder—first treating with the coupling agent then with the hyperbranched resin—is based on the low viscosity and surface tension of the coupling agent, which grant it strong wetting ability. The coupling agent can rapidly spread over the surface of the distiller's grains powder, effectively wetting it and ensuring uniform distribution, thereby enhancing the compatibility and dispersion among the various component materials. Once the distiller's grains powder surface is wetted, the functional groups on the coupling agent molecules diffuse towards surfaces with similar polarity. In the embodiment 2, alkoxy groups at one end of the coupling agent KH560 to form silanol groups, which orient towards the surface of the distiller's grains containing numerous hydroxyl groups and engage in hydrolysis-condensation reactions with hydroxyls on this surface. The organic groups, meanwhile, orient towards the surfaces of the hyperbranched resin and the biodegradable resin. During processing, chemical reactions occur, thereby completing the coupling process between the distiller's grains powder, the hyperbranched resin, and the biodegradable resin.

In summary, in the disclosure, the used coupling agent molecules possess both organic groups that are compatible with the hyperbranched resin and the biodegradable resin matrix, and groups that are compatible with the distiller's grains powder material. Among these, the organic groups significantly influence the properties of the final product. Only when the organic groups can react with the corresponding hyperbranched resin and biodegradable resin matrix, the performance of the composite material can be enhanced. The disclosure selects three different types of coupling agents: KH-560 bearing terminal epoxy reactive groups, KH-550 bearing terminal amino reactive groups, and NDZ-201 bearing terminal hydroxyl-reactive groups. These reactive groups are all capable of undergoing chemical reactions with the reactive groups present on the distiller's grains, the hyperbranched resins with different terminal groups, and the biodegradable resins. Regarding the selection of the hyperbranched resins, based on the different terminal reactive end groups of the hyperbranched resins, the disclosure selects amino-terminated hyperbranched polyester, carboxyl-terminated hyperbranched polyester, hydroxyl-terminated hyperbranched polyester, and hyperbranched epoxy resin to match the different types of the coupling agents and the biodegradable resins. This approach ultimately yields a biodegradable green composite material with excellent properties, while simultaneously aiming to increase the content of the distiller's grains powder in the composite without compromising product standards and performance, thereby accelerating the consumption of the distiller's grains powder. Among the embodiments 1-22 of the disclosure, the embodiment 2 demonstrates the best overall performance and is identified as an optimal embodiment.

The embodiments provided above are merely specific embodiments of the disclosure and do not limit the scope thereof. Any modifications and improvements made by those skilled in the art to the technical solutions of the disclosure, without departing from the spirit of the design of the disclosure, should all fall within the scope of protection defined by the appended claims of the disclosure.

What is claimed is:

1. A preparation method of a modified distiller's grains, comprising the following steps:
(1) crushing distiller's grains, followed by drying, grinding, and sieving to obtain distiller's grains powder;
(2) adding a coupling agent to the distiller's grains powder, followed by heating and stirring to obtain coupling agent-treated distiller's grains; and
(3) adding a hyperbranched resin to the coupling agent-treated distiller's grains, followed by heating, stirring for 5 minutes (min) to 45 min, and cooling to room temperature to obtain the modified distiller's grains;
wherein a weight ratio of the distiller's grains powder to the coupling agent is (10:1) to (300:1), and the coupling agent is γ-aminopropyltriethoxysilane; and
wherein a weight ratio of the distiller's grains powder to the hyperbranched resin is 50:1, and the hyperbranched resin is carboxyl-terminated hyperbranched polyester Hyper C304.

2. The preparation method as claimed in claim 1, wherein a drying temperature of the drying in the step (1) is 80° C. to 120° C., and a particle size of the distiller's grains powder is 100 mesh to 2,000 mesh.

3. A distiller's grains-based fully biodegradable green composite material, wherein in terms of weight percent, a composition of the distiller's grain-based fully biodegradable green composite material comprises: 5 wt % to 95 wt % of biodegradable polyester, 0.1 wt % to 15 wt % of chain extender, 1 wt % to 75 wt % of the modified distiller's grains, 0.1 wt % to 5 wt % of anti-hydrolysis agent, 0.1 wt % to 5 wt % of thermal stabilizer, and 0.1 wt % to 7.5 wt % of lubricant; and the modified distiller's grains is prepared by the preparation method as claimed in claim 1.

4. The distiller's grains-based fully biodegradable green composite material as claimed in claim 3, wherein the biodegradable polyester is at least one selected from the group consisting of poly(butylene adipate-co-terephthalate) (PBAT), polylactic acid (PLA), poly(butylene succinate) (PBS), poly(butylene succinate-co-butylene adipate) (PBSA), poly(propylene carbonate) (PPC), poly(glycolic acid) (PGA), poly(ε-caprolactone) (PCL), poly(hydroxyalkanoate) (PHA), poly(hydroxybutyrate) (PHB), poly(hydroxyvalerate) (PHV), and poly(hydroxybutyrate-co-hidroxyvalerate) (PHBV); the chain extender is at least one selected from the group consisting of an epoxy compound chain extender and a styrene-methyl acrylate copolymer chain extender; the anti-hydrolysis agent is at least one selected from the group consisting of a carbodiimide compound, an isocyanate compound, a bisoxazoline compound, and an epoxy compound; the thermal stabilizer is at least one selected from the group consisting of an aromatic amine compound, a hindered phenol compound, a phosphite compound, and a thioester compound; and the lubricant is at least one selected from the group consisting of a long-chain carboxylic acid, an amide wax, a carboxylic acid ester, a carboxylic acid salt, and an organosilicon resin.

5. A preparation method of the distiller's grains-based fully biodegradable green composite material as claimed in claim 3, comprising:
mixing the biodegradable polyester, the chain extender, the anti-hydrolysis agent, the thermal stabilizer, and the lubricant to obtain a biodegradable polyester mixture; and
mixing the biodegradable polyester mixture with the modified distiller's grains, followed by drying thoroughly to obtain the distiller's grains-based fully biodegradable green composite material.

6. A use of the distiller's grains-based fully biodegradable green composite material as claimed in claim 3 as a material for blow molding, injection molding, cast film extrusion, rotational molding, three-dimensional (3D) printing, extrusion, coating, spinning, thermoforming, and compression molding.
